(19) United States
(12) Patent Application Publication
(10) Pub. No.: US 2017/0185865 A1
(43) Pub. Date: Jun. 29, 2017

(54) Method and electronic apparatus of image matching

(71) Applicants: Le Holdings (Beijing) Co., Ltd., Beijing (CN); LeCloud Computing Co., Ltd., Beijing (CN)

(72) Inventors: Fan Yang, Beijing (CN); Yang Liu, Beijing (CN); Yangang CAI, Beijing (CN); Maosheng Bai, Beijing (CN); Wei Wei, Beijing (CN)

(21) Appl. No.: 15/247,000

(22) Filed: Aug. 25, 2016

Related U.S. Application Data
(63) Continuation of application No. PCT/CN2016/088691, filed on Jul. 5, 2016.

(30) Foreign Application Priority Data
Dec. 29, 2015 (CN) 201511017712.5

(51) Int. Cl. G06K 9/62; G06K 9/38; G06K 9/42; G06K 9/64

(52) U.S. Cl. CPC G06K 9/6215; G06K 9/64; G06K 9/38; G06K 9/42

(57) ABSTRACT

A method and electronic apparatus for image matching, including: determining matching area in image according to where search frame is located in the image; calculating average gray-scale value of pixels in each column/row in the matching area, calculating average gray-scale value of pixels in the matching area in any consecutive columns/rows corresponding to the quantity of the columns/rows in any one of the pre-built template samples, calculating similarity between the average gray-scale value of the pixels in the matching area and average gray-scale value of the pixels in columns/rows of the template sample, and taking the template sample having the maximum similarity as an image matching template sample. Therefore, the traditional process of assembling collected images together is removed for preventing the problem in matching imprecisely. The process of assembling images is removed by several independent template samples, so the result of image matching is precise.

### CROSS REFERENCE TO RELATED APPLICATIONS

This application is a continuation of International Application No. PCT/CN2016/088691, filed on Jul. 5, 2016, which is based upon and claims priority to Chinese Patent Application No. 201511017712.5, filed on Dec. 29, 2015, the entire contents of which are incorporated herein by reference.

### TECHNICAL FIELD

The disclosure relates to an image processing technology, more particularly to a method and electronic apparatus for image matching.

### BACKGROUND

When a general method of collecting image is used to generate a template sample from an image on a curved surface of a cylinder, only a part of the front side of the image is collected in each collection, the whole image cannot be collected.

Accordingly, a linear array camera is provided to collect image on each row of the curved surface, and all the images collected from the rows are put together to be assembled into a complete template sample. However, the linear array camera costs too much money, and is large in size, which is not favorable for a light and low-cost apparatus.

In another general solution, each part of the image is conducted with image collection, and then a complete template sample is provided directly by using an image mosaicing method. However, the parts more close to two opposite sides of the curved surface have greater distortion, so the collected image fails to meet high precision required by the image mosaicing method. In such a case, the collected images are not well connected at curved surface. In addition, for an image having fewer features, the image mosaicing method is more unadaptable and fails to precisely matching the image on the curved surface.

### SUMMARY

The present disclosure provides a method and electronic apparatus of image matching for solving the problem that the traditional technique fails to precisely matching the image on the curved surface.

One embodiment of the present disclosure provides a method of image matching, the method includes:

S101: determining a matching area in an image according to where a search frame is located in the image, wherein a size of the matching area is greater than a size of a template sample;

S102: calculating average gray-scale value of pixels in each column/row in the matching area, calculating average gray-scale value of pixels in the matching area in any consecutive columns/rows corresponding to the quantity of the columns/rows in any one of the pre-built template sample, calculating similarity among the average gray-scale value of the pixels in the matching area and average gray-scale value of pixels in columns/rows of the template sample, and taking the template sample corresponding to the maximum similarity as a matching template sample; and

S103: taking an area where the pixels in the columns/rows of the matching area corresponding to the maximum similarity as a target area.

One embodiment of the present disclosure provides a non-volatile computer storage medium capable of storing computer-executable instruction. The said computer-executable instruction is used for performing any one of the methods for image matching as discussed in above.

One embodiment of the present disclosure provides an electronic apparatus, includes: at least one processor and memory; wherein the memory stores at least one process which can be performed by the processor. The computer-executable instruction is performed by the at least one processor so that the at least one processor can perform any one of the methods for image matching as discussed in above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method of image matching according to the present disclosure;

FIG. 2 is a flow chart of a method of image matching according to one embodiment of the present disclosure;

FIG. 3 is a flow chart of a method of image matching according to one embodiment of the present disclosure;

FIG. 4 is a flow chart of a method of image matching according to one embodiment of the present disclosure;

FIG. 5 is a flow chart of a method of image matching according to one embodiment of the present disclosure;

FIG. 6 is a schematic view of a process of collecting image from a standard sample image according to one embodiment of the present disclosure;

FIG. 7 is a schematic view of a binarized sample provided in the process of generating template sample according to one embodiment of the present disclosure;

FIG. 8 is a schematic view of a matching area according to one embodiment of the present disclosure;

FIG. 9 is a schematic view of a row area of the matching area being row matched according to one embodiment of the present disclosure;

FIG. 10 is a schematic view of an electronic apparatus for matching image according to one embodiment of the present disclosure;

FIG. 11 is a schematic view of an electronic apparatus for matching image according to one embodiment of the present disclosure; and

FIG. 12 is a schematic view of an electronic apparatus for matching image according to one embodiment of the present disclosure.

### DETAILED DESCRIPTION

For more clearly illustrating the purpose, technology and advantages of the present disclosure, the following paragraphs and related drawings are provided for thoroughly describing the features of the embodiments of the present disclosure. It is evident that these embodiments are merely illustrative and not exhaustive embodiments of the present disclosure. Based on the embodiments in the present disclosure, the other embodiments conceived by the people skilled in the art without putting inventive effort fall within the scope of the present disclosure.

One embodiment of the present disclosure provides a method and electronic apparatus of image matching, and the method and electronic apparatus are adaptable to image detecting. General, when detecting and matching image on a curved surface, a linear array camera is usually used to scan the columns/rows of the image to get a complete image as a template sample by assembling the scanned images together, but the linear array camera costs too much money. In addition, when the image mosaicing method is used to put part of the image together to form into a complete image as a template sample, the result fails to meet high precision. Accordingly, the method and electronic apparatus of the present disclosure are used to solve the aforementioned problem. Several of independent template samples are built in advance, matching areas in the image are respectively column matched to the several template samples, and related parameters of the matching samples can be determined according to the result of image matching, the related parameter is, for example, whether or not the image has defect.

In addition, the method and electronic apparatus of the present disclosure can be adapted to other image matching applications, but the present disclosure is not limited thereto.

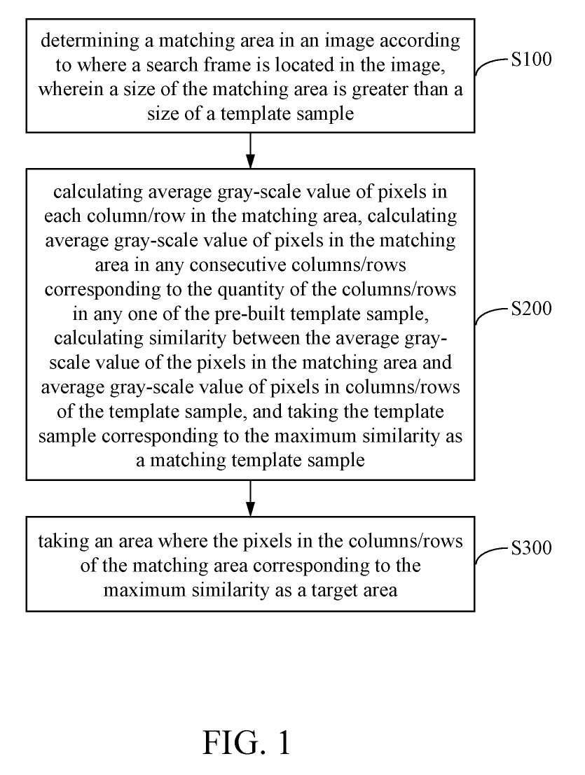

Please refer to FIG. 1, the present disclosure provides a method of matching image, the method includes:

S100: determining a matching area in an image according to where a search frame is located in the image, wherein a size of the matching area is greater than a size of a template sample;

S200: calculating average gray-scale value of pixels in each column/row in the matching area, calculating average gray-scale value of pixels in the matching area in any consecutive columns/rows corresponding to the quantity of the columns/rows in any one of the pre-built template sample, calculating similarity among the average gray-scale value of the pixels in the matching area and average gray-scale value of pixels in columns/rows of the template sample, and taking the template sample corresponding to the maximum similarity as a matching template sample; and

S300: taking an area where the pixels in the columns/rows of the matching area corresponding to the maximum similarity as a target area.

Wherein, in the step S100, the matching area on the image determined by the search frame can be taken as an area used to be compared with the template sample in the following processes. The size of the matching area is greater than the size of the template sample, so the problem in matching imprecisely caused by the location of the pattern in the image can be prevented. The final template sample can match a part of the matching area, for example, as shown in FIG. 8, the range of the black background corresponds to the size of the matching area, and the range of the border of the black background represents the size of the template sample.

In the step S200, the average gray-scale value in column/row in the matching area is calculated first, and then the average gray-scale value in each column in the matching area is compared with average gray-scale value in each column in the several template samples, or the average gray-scale value in each row in the matching area is compared with average gray-scale value in each row in the several template samples. The size of the matching area is greater than the size of the template sample, so the quantity of the average gray-scale value in column/row of the matching area is greater than the quantity of the average gray-scale value in column/row of the template sample. During the comparison, in each template sample, average gray-scale value of pixels in the matching area in any consecutive columns/rows corresponding to the quantity of the columns/rows in the template sample are calculated, the similarity among the average gray-scale value of the pixels in the matching area and average gray-scale values of the pixels in columns/rows of the template sample is calculated, the template sample corresponding to the maximum similarity and a target area in the matching area can be determined by matching and comparing, e.g. in FIG. 8, the range of the border is the target area, and the size of the determined target area is the same as the size of the template sample.

The gray-scale values of the pixels are different in different images, features of pixels in each column/row of the matching area can be determined according to average gray-scale value in column/row of the matching area. Specifically, the average gray-scale value in column/row is calculated after the image is converted into a binarized image, and during the calculation of the average gray-scale value in column/row, the gray-scale values of the pixels in the area of the matching area larger than (outside) the template sample is defined as 0, thus, during the calculation of the average gray-scale value in column/row, the quantity of the pixels in each column/row is defined as the same as the quantity of the pixels in each column/row of the template sample. If the average gray-scale value in each column/row in the template sample matches the quantity in the matching area, and the average gray-scale value in adjacent columns/rows are matched to each other, it proofs that the pattern of the template sample is the same as or highly similar to the pattern of the target area in the matching area. By doing so, the template sample adapted to industrial processing or other applications can be determined, and the target area can be determined from the image. For example, the method can be used to analyze defect or printing quality in the target area.

In the step S200, the calculation of the average gray-scale value of pixels of the matching area in any consecutive columns/rows corresponding to the quantity of the columns/rows of the template sample, and calculation of the similarity among the average gray-scale value of the pixels in the matching area and the average gray-scale value in column/row of the template sample can be implemented by various ways, there are several embodiments for exemplary explaining the calculations.

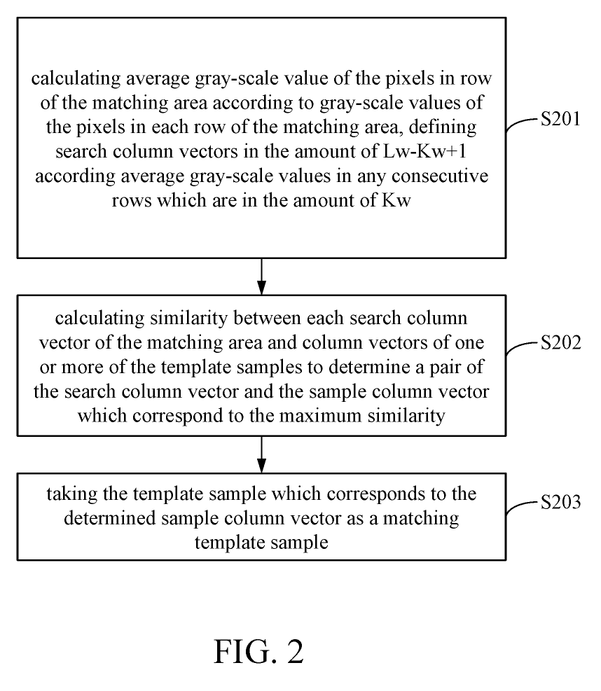

Please refer to FIG. 2, in the method of the present disclosure, the step S200 includes:

S201: calculating average gray-scale value of the pixels in row of the matching area according to gray-scale values of the pixels in each row of the matching area, defining search column vectors in the amount of L_{w}−K_{w}+1 according to average gray-scale values in any consecutive rows which are in the amount of K_{w}, wherein K_{w} represents the quantity of the rows in the template sample, L_{w} represents the quantity of the rows in the matching area, and L_{w}>K_{w};

S202: calculating similarity between each search column vector of the matching area and column vectors of the several template samples to determine a pair of the search column vector and the sample column vector which correspond to the maximum similarity; and

S203: taking the template sample which corresponds to the determined sample column vector as a matching template sample.

In this embodiment, in the step S201, the average gray-scale value of the pixels in each row of the matching area can be calculated according to pᵥ(j)=1/K_{w}Σᵢ₌₀^{i=L}^{_{w}}⁻¹Q(i,j)

wherein Q(i,j) represents gray-scale value of pixel in the matching area, i represents column coordinate of pixel, j represents row coordinate of pixel, K_{w} represents the quantity of the rows of the template sample. By calculation, the average gray-scale values in row in the amount of L_{w} of the matching area are obtained, and any adjacent average gray-scale values in row in the amount of K_{w} is defined as a search column vector. For example, the 0^{th}˜K_{w}−1^{th} average gray-scale values in row is defined as a search column vector, or the 1^{st}˜K_{w}^{th}, the 2^{nd}˜K_{w}+1^{th}, the 3^{rd}˜K_{w}+2^{nd} average gray-scale values in row can be defined as a search column vector. By doing so, it is noted that the quantity of the search column vectors is L_{w}−K_{w}+1. The length of the search column vector is the same as the length of the sample column vector in the template sample. For the search column vectors in the amount of L_{w}−K_{w}+1 defined by the step S201, in the step S202, each search column vector is compared with the sample column vectors of the several template samples which are built in advance, and the similarity between the search column vector and the sample column vector is calculated. If the quantity of the template samples is N, then the quantity of the calculated similarities will be N*(L_{w}−K_{w}+1), and then the maximum similarity is selected from these calculated similarities, and the template sample having the sample column vector corresponding to the maximum similarity is taken as a matching template sample. In the step S300, an area where the pixels in the matching area corresponding to the search column vector corresponding to the maximum similarity is taken as a target area.

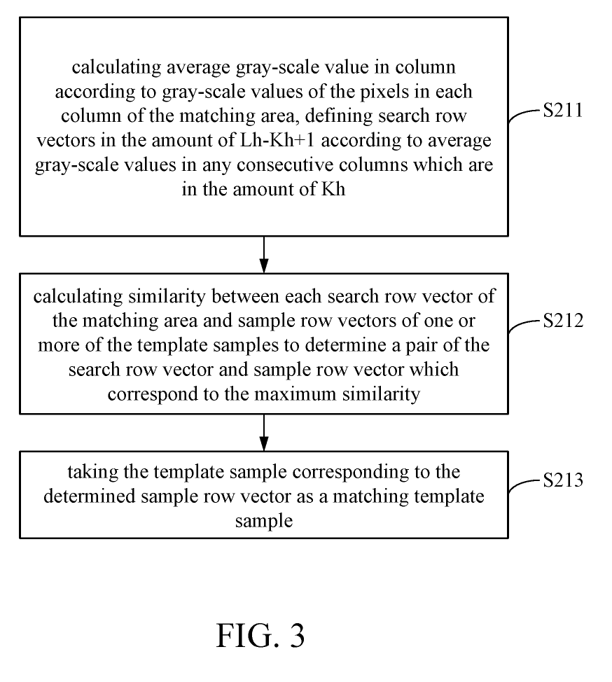

Please refer to FIG. 3, the step S200 includes:

S211: calculating average gray-scale value in column according to gray-scale values of the pixels in each column of the matching area, defining search row vectors in the amount of Lₕ−Kₕ+1 according to average gray-scale values in any consecutive columns which are in the amount of Kₕ, wherein Lₕ represents the quantity of the columns in the matching area, Kₕ represents the quantity of the columns in the template sample, and Lₕ>Kₕ;

S212: calculating similarity between each search row vector of the matching area and sample row vectors of the several template samples to determine a pair of the search row vector and sample row vector which correspond to the maximum similarity; and

S213, taking the template sample corresponding to the determined sample row vector as a matching template sample.

In this embodiment, in the step S211, the average gray-scale value of the pixels in each column of the matching area can be calculated according to

$${p}_{h} ( i ) = \frac{1}{{K}_{h}} {\sum }_{j = 0}^{j = {L}_{h} - 1} Q ( i , j ) ,$$

wherein Q(i,j) represents gray-scale value of each pixel in the matching area, i represents column coordinate of pixel, j represents row coordinate of pixel, Kₕ represents the quantity of the columns of the template sample. By the calculation, the average gray-scale values in column in the amount of Lₕ of the matching area are obtained, and any adjacent average gray-scale values in column in the amount of Kₕ is defined as a search row vector. For example, the 0^{th}˜Kₕ−1^{th} average gray-scale values in column is defined as a search row vector, or the 1^{st}˜Kₕ^{th}, the 2^{nd}˜Kₕ+1^{th}, or the 3^{rd}˜Kₕ+2^{nd} average gray-scale values in column can be defined as a search row vector. By doing so, it is noted that the quantity of the search row vectors is Lₕ−Kₕ+1. The length of the search row vector is the same as the length of the sample row vector of the template sample. For the search row vector in the amount of Lₕ−Kₕ+1 defined by the step S211, in the step S212, each search row vector is compared with the sample row vector of the several template samples, and the similarity between the search row vector and the sample row vector is calculated. If the quantity of the template samples is N, then the quantity of the calculated similarities will be N*(Lₕ−Kₕ+1), and then the maximum similarity is selected from these calculated similarities, and the template sample having the sample row vector corresponding to the maximum similarity is taken as a matching template sample. In the step S300, an area where the pixels in the matching area having the search row vector corresponding to the maximum similarity is taken as a target area.

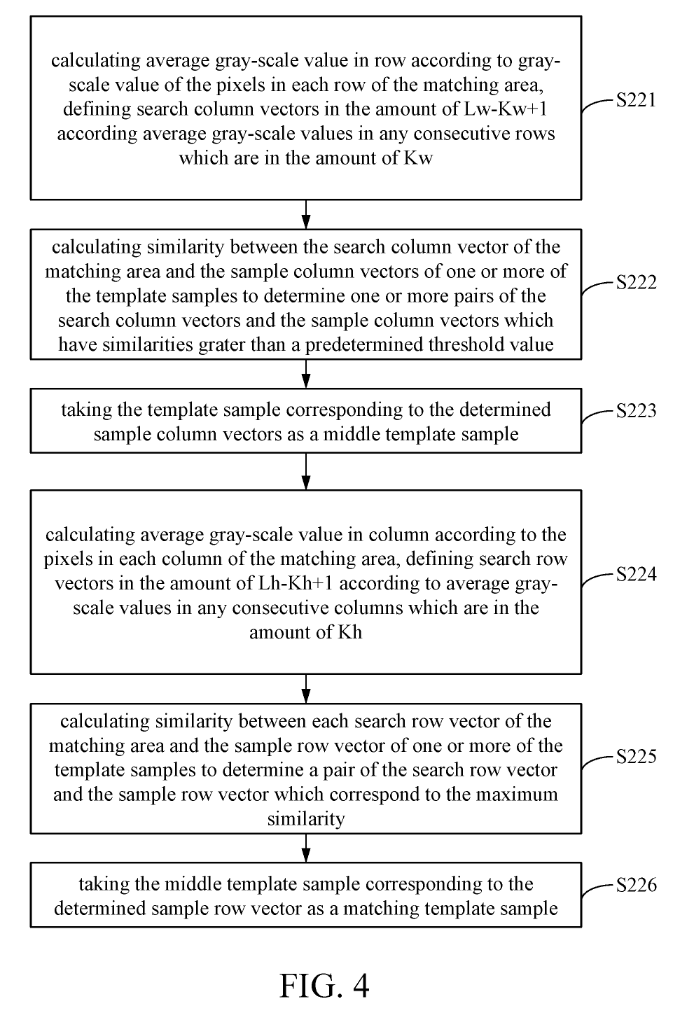

Please refer to FIG. 4, the step S102 includes:

S221: calculating average gray-scale value in row according to gray-scale value of the pixels in each row of the matching area, defining search column vectors in the amount of L_{w}−K_{w}+1 according to average gray-scale values in any consecutive rows which are in the amount of K_{w}, wherein L_{w} represents the quantity of the rows in the matching area, K_{w} represents the quantity of the rows in the template sample, and L_{w}>K_{w};

S222: calculating similarity between the search column vector of the matching area and the sample column vectors of the several template samples to determine several pairs of the search column vectors and the sample column vectors which have similarities grater than a predetermined threshold value;

S223: taking the template sample corresponding to the determined sample column vectors as a middle template sample;

S224: calculating average gray-scale value in column according to the pixels in each column of the matching area, defining search row vectors in the amount of Lₕ−Kₕ+1 according to average gray-scale values in any consecutive columns which are in the amount of Kₕ, wherein Lₕ represents the quantity of the columns in the matching area, Kₕ represents the quantity of the columns in the template sample, and Lₕ>Kₕ;

S225: calculating similarity between each search row vector of the matching area and the sample row vector of the several template samples to determine a pair of the search row vector and the sample row vector which correspond to the maximum similarity;

S226: taking the middle template sample corresponding to the determined sample row vector as a matching template sample.

In this embodiment, in the step S221, the average gray-scale value of the pixels in each row of the matching area can be calculated according to

$${p}_{v} ( j ) = \frac{1}{{K}_{w}} {\sum }_{i = 0}^{i = {L}_{w} - 1} Q ( i , j ) ,$$

wherein Q(i,j) represents gray-scale value of each pixel in the matching area, i represents column coordinate of pixel, j represents row coordinate of pixel, K_{w} represents the quantity of the rows of the template sample. By the calculation, the average gray-scale values in row in the amount of L_{w}s of the matching area are obtained, and any adjacent average gray-scale values in row in the amount of K_{w} are defined as a search column vector to define that the search column vectors is in the amount of Lₕ−Kₕ+1. The length of the search column vector is the same as the length of the sample column vector in the template sample. For the search column vectors in the amount of Lₕ−Kₕ+1 defined by the step S221, in the step S222, each search column vector is compared with the sample column vectors of the several template samples which are built in advance, and the similarity between the search column vector and the sample column vector is calculated. If the quantity of the template samples is N, then the quantity of the calculated similarities will be N*(L_{w}−K_{w}+1), and then the similarity greater than the predetermined threshold value is selected from these calculated similarities, or a predetermined amount of the relatively strong similarities arranged in the top of a list of all the calculated similarities are selected. In the step S223, the template sample having the selected similarity is taken as the middle template sample. The quantity of the middle temple samples determined in the steps S221˜223 is much less than the quantity of the template samples. After the column matching process of the matching area and the middle temple sample determined in the step S224-226, the maximum similarity is selected from the similarities among each search row vector of the matching area and the sample row vector of the middle template samples, and the middle template sample corresponding to the maximum similarity is taken as a matching template sample.

In this embodiment, the matching area and all the template sample are conducted with row matching process to choose several template samples having highly matched rows to be taken as middle template samples, and then the matching area and the middle template samples are conducted with column matching process to choose the middle template sample having the highest column matching to be taken as a matching template sample. By two matching processes, the relationship among the matching area and the template samples can be confirmed more precise, so it is favorable for determining the target area in the matching area and analyzing the target area.

In addition, this embodiment provides an exemplary explanation that the process of row matching the matching area and all the template samples is ahead of the process of column matching the matching area and the middle template samples, similarly, it is acceptable to perform column matching the matching area and all the template sample first, and then perform row matching the matching area and the middle template sample, the result of image matching is precise as well.

Please refer to FIG. 8, the step S200 includes:

S231: calculating average gray-scale value in row according to gray-scale values of the pixels in each row of the matching area, defining search column vectors in the amount of L_{w}−K_{w}+1 according to average gray-scale values in any consecutive rows which are in the amount of K_{w}, wherein L_{w} represents the quantity of the rows in the matching area, K_{w} represents the quantity of the rows in the template sample, and L_{w}>K_{w};

S232: calculating similarity between the search column vector of the matching image and the sample column vectors of the several template samples to determine the maximum similarity corresponding to each template sample;

S233: taking the template sample having the maximum similarity greater than the predetermined threshold value as a middle template sample according to the maximum similarity corresponding to each template sample;

S234: determining a row area in the matching area according to the search column vector corresponding to the middle template sample, calculating average gray-scale value of the pixels in each column in the row area in the matching area, defining search row vectors in the amount of Lₕ−Kₕ+1 according to average gray-scale values in any adjacent columns which are in the amount of Kₕ, wherein Lₕ represents the quantity of the columns in the matching area, Kₕ represents the quantity of the columns in the template sample, and Lₕ>Kₕ;

S235: calculating similarity between the sample row vector of the middle template sample and the search row vector in the row area in the matching area;

S236: determining the maximum among the similarities among the sample row vectors of the middle template samples and the search row vectors of the row areas in the matching area, and taking the middle template sample corresponding to the maximum one as a matching template sample.

In step S231, average gray-scale value of the pixels in each row is calculated according to

$${p}_{v} ( j ) = \frac{1}{{K}_{h}} {\sum }_{i = 0}^{i = {L}_{h} - 1} Q ( i , j ) ,$$

wherein Q(i,j) represents gray-scale value of each pixel in the matching area, i represents column coordinate of pixel, j represents row coordinate of pixel, K_{w} represents the quantity of the rows of the template sample. Here, by comparing the matching area with the template sample, the gray-scale values of the extra pixels in each row are 0, according to the aforementioned formula, the quantity of the usable pixels in row of the matching area is taken as a calculation standard of the average gray-scale value in row, and the quantity of the usable pixels in row is the same as the quantity of the pixels in row of the template sample. Therefore, the similarity between the average gray-scale value in row and the average gray-scale value in row of the template sample can be precise. By calculation, average gray-scale values in row in the amount of L_{w} of the matching area are obtained, any adjacent average gray-scale values in row in the amount of K_{w} are defined as a search column vector, and the quantity of the search column vectors is defined as L_{w}−K_{w}+1. For each template sample, its sample column vectors are conducted with similarity calculation with the search column vectors in the amount of L_{w}−K_{w}+1 in the matching area, each template sample will obtain similarities in the amount of L_{w}−K_{w}+1, and a maximum similarity is selected from these similarities. If the quantity of the template samples is N, then there are maximum similarities in the amount of N be obtained by the step S232. By step S233, a certain amount of maximum similarities or the maximum similarities greater than the predetermined threshold value are selected from these maximum similarities. These maximum similarities can be arranged in order, and a predetermined amount of the maximum similarities arranged in the top of a list of all the calculated maximum similarities are selected. The template sample having the selected maximum similarity is taken as a middle template sample.

For each middle template sample, a row area in the matching area corresponding to the middle template sample shown in FIG. 9 can be obtain according to the relationship between the sample column vector and the search column vector of the matching area, the matching area is performed oppositely matching by the step S234 from the angle of the middle template sample, when determining the row area of the matching area, average gray-scale value of the pixels in each column in the row area is calculated according to

$${P}_{h} ( i ) = \frac{1}{{K}_{w}} {\sum }_{j = 0}^{j < {K}_{w}} I ( i , j )$$

to obtain average gray-scale values in column in the amount of Lₕ. According to the obtained average gray-scale values in column in the amount of Lₕ, the quantity of the search row vectors in the length of Kₕ is Lₕ−Kₕ+1, and the length of the search row vector is the same as the length of the sample row vector of the middle template sample. Then, by the step S235, the similarity between the column vector of the middle template sample and the search row area of the matching area is calculated for determining the maximum similarity corresponding to each middle template sample. By the step S236, the maximum among these maximum similarities determined in the step S235 is determined, the middle template sample corresponding to the maximum one is taken as the matching template sample, and an area in the matching area where the search column vector and the search row vector correspond to the maximum one is taken as the target area.

In this embodiment, the matching area and all the template samples are conducted with row matching process, maximum similarity between each template sample and the matching area is obtained, several preferable middle template samples are selected according to the maximum similarity of each template sample, and then the best matching row area in the matching area corresponding to these middle template samples is determined; and then the determined row area of the matching area and the middle template sample are conducted with matching process, this matching process is merely used to calculate the average gray-scale value in column in the determined row area. By S234, search row vector of the matching area is defined according to the average gray-scale value in each column in the calculated row area. By S235, similarity between the calculated search row vector and the sample row vector of the middle template sample is calculated. If the quantity of the template samples is n, and then there are similarities in the amount of n*(Lₕ−Kₕ+1), and the maximum one is selected from these similarities, and the middle template sample corresponding to the maximum one is taken as a matching template sample. Wherein, by S235, the maximum among the similarities in the amount of n*(Lₕ−Kₕ+1) is selected, the maximum similarity corresponding to each middle template sample can be calculated first, and then the maximum among these maximum similarities in the amount of n is selected, or the maximum among these similarities in the amount of n*(Lₕ−Kₕ+1) is selected, and the other ways of selecting are adaptable, the present disclosure it not limited thereto.

In addition, it is noted that: this embodiment provides an exemplary explanation that the process of matching the matching area and the rows of all the template samples is ahead of the process of row matching the row area of the matching area, and the process of column matching the middle template sample, similar, it is acceptable to perform column matching area and all the template samples first, and then perform column matching to determine the column area of the matching area and perform row matching of the middle template sample, the result of image matching is precise obtained as well. These two methods both fall within the scope of the present disclosure. By this embodiment, several most matching column/row areas of the matching area and the template sample can be confirmed, and then the matched column/row areas are conducted with row/column matching to ensure that the target area is more precise. The result of matching is precise in the position of the pixel in the image, thus, it can provide more precise result than the traditional methods do.

In the embodiments in above, when calculating the similarity, there are many usable ways, here is a similar exemplary explanation of angle among vectors for calculating similarity.

In the embodiments in above, the similarity among the search column/row vector of the matching area and sample column/row vector of the template sample is calculated according to

$${d}_{n , m} = \frac{{p}^{m , m + {K}_{w} - 1} \cdot P ( n )}{\vert {p}^{m , m + {K}_{w} - 1} \vert \times \vert P ( n ) \vert} ,$$

wherein, m represents that the search column/row vector is started from row/column average gray-scale value in the m^{th} row/column in the matching area, P (n) represents sample column/row vector in the n^{th} template sample, p^{m,m+K}^{_{w}}⁻¹ represents search column/row vector of the matching area.

For example, the angle between the search column vector defined by the 0˜K_{w}−1^{th} row average value and the column vector of the template sample is calculated according to

$${θ}_{n , 0} = {cos}^{- 1} [ \frac{{p}_{v}^{0 , {K}_{w} - 1} \cdot {P}_{v} ( n )}{\vert {p}_{v}^{0 , {K}_{w} - 1} \vert \times \vert {P}_{v} ( n ) \vert} ] ,$$

and wherein the form of

$$\frac{{p}_{v}^{0 , {K}_{w} - 1} \cdot {P}_{v} ( n )}{\vert {p}_{v}^{0 , {K}_{w} - 1} \vert \times \vert {P}_{v} ( n ) \vert}$$

is taken as the similarity d_{n, 0} between the two vectors, when the similarity is greater, the angle between the two vectors is smaller. Similarly, the similarity between the search row vector of the matching area and the template sample is calculated according to

$${d}_{n , m} = \frac{{p}^{m , m \vert {K}_{w} - 1} \cdot P ( n )}{\vert {p}^{m , m + {K}_{w} - 1} \vert \times \vert P ( n ) \vert} .$$

In the embodiments in above, they can get different amount of similarities according to different calculation parameters, comparative targets, they finally all can find a pair of sample column/row vector and search column/row vector which have smallest difference and highest matching level, and thereby precisely determining the target area matching the template sample and the matching area.

There is another embodiment for explaining the process of pre-building the template sample in detail. The pre-building of the template sample provides the basic for calculating the similarity in the above embodiments, the process of the pre-building of the template sample is finished before the calculation of the similarity in the above embodiments.

In this embodiment, the process of pre-building the template sample includes:

S401: collecting image from standard sample image according to image collecting frame, obtaining several collected image samples, binarizing the collected image sample to obtain binarized sample, wherein, the size of the image collecting frame is K_{w}*Kₕ;

S402: calculating an average gray-scale value of the pixels in each column and an average gray-scale value of the pixels in each row in the binarized sample, defining all the average values in columns in the binarized sample as sample row vector having a length which is K_{w}, defining all the average values in rows in the binarized sample as sample column vector having a length which is Kₕ;

S403: numbering each binarized sample, and taking the several binarized samples which are numbered and have defined sample row vector and sample column vector as template samples.

Wherein, in the step S401, the period of collecting image can be set according to actual condition, the image collecting can be conducted in each 3˜5 degrees to prevent the image collecting from costing too much time, and ensure the collected image sample meets requirement. The sample image should be standard sample in order to prevent from generating imprecise template sample while collecting image on non-standard sample. In addition, the image collecting frame should face the standard sample image while collecting image, and the size of the image collecting frame should not be too big in order to prevent the collected image sample from distorting to generate imprecise template sample while the size of the collected image is too big. In addition, the process of binarizing is used to convert the gray-scale values of value 0 and value 255, there are many ways for converting. For example, if the luminance of the image is stable, the Valve Binarization can be used to collect the image to convert gray-scale value, the other methods, e.g. Top Hat, Black Hat, edge extraction, the present disclosure is not limited thereto.

In step S402, in the binarized sample obtained by the binarizing process, average gray-scale value in column and average gray-scale value in row is calculated column by column and row by row, average gray-scale value in column of the binarized sample is calculated according to

$${P}_{h} ( i ) = \frac{1}{{K}_{w}} {\sum }_{j = 0}^{j < {K}_{w}} I ( i , j ) ,$$

average gray-scale value in row of the binarized sample is calculated according to

$${P}_{v} ( j ) = \frac{1}{{K}_{h}} {\sum }_{i = 0}^{i < {K}_{h}} I ( i , j ) ,$$

wherein, I(i,j) represents gray-scale value of pixel in the binarized sample, i represents column coordinate of pixel, j represents row coordinate of pixel, K_{w} represents the quantity of the rows of the binarized sample, Kₕ represents the quantity of the columns of the binarized sample. By step S402, the average gray-scale values in row in the amount of K_{w} and the average gray-scale values in column in the amount of Kₕ are obtained, and these average gray-scale values in row in the amount of K_{w} of the binarized sample are defined as sample column vector, these average gray-scale values in column in the amount of Kₕ are defined as sample row vector.

In step S403, the sample row vector and the sample column vector calculated by the step S402 are numbered in the binarized sample to generate template samples, and the template samples are numbered as well for conveniently finding the matching template sample while matching image in the later processes.

Preferably, in this embodiment, steps before the step of binarizing the collected image sample to obtain the binarized sample further includes:

deleting useless collected image sample, wherein the useless collected image sample comprises: the collected image having an image collecting angle having a difference less than a predetermined threshold value with respect to an image collecting angle of the pervious collected image sample; or the collected image sample having no image.

Deleting useless collected image sample is used to shortening time of sample analysis, wherein the final amount of the collected image sample ranging between 80 and 180 satisfies the requirement of image collecting.

This embodiment change the traditional method that the template sample should be the whole image, it generates plural independent template samples for image matching, thus, the process of assembling images are removed, and thereby preventing the problem in matching imprecisely caused by images assembling; Also, in this embodiment, each template sample has numbered sample row vector and sample column vector for achieving high-precise image matching.

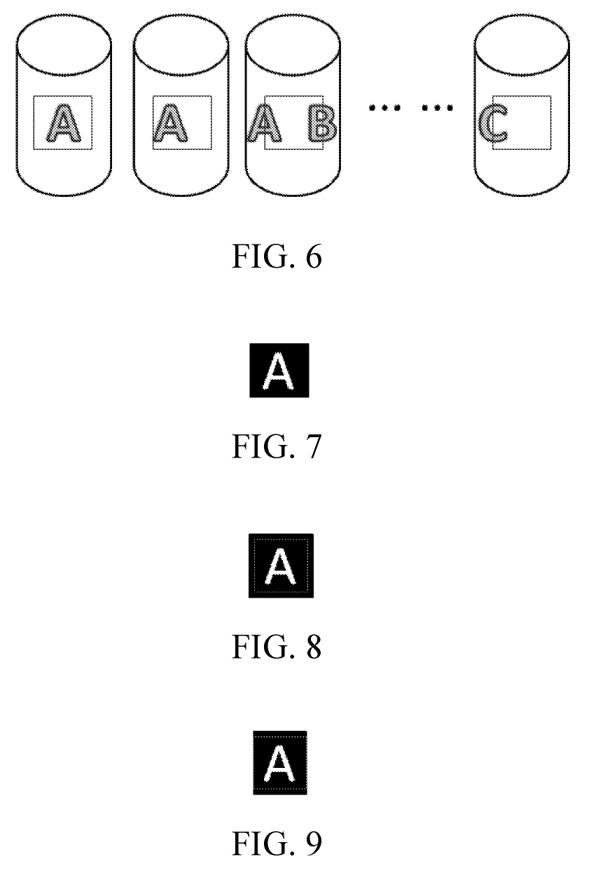

An image on a curved surface as shown in FIG. 6 is an example for explaining the embodiments in detail.

Firstly, a cylindrical standard sample in FIG. 6 is rotated, and the image collecting frame is placed to aim at the center of the front side of the sample to collect image on the curved surface, several collected image samples are obtained, and useless collected image samples are deleted, a binarized sample as shown in FIG. 4 is obtained by binarizing the collected image samples in the amount of N, and then the binarized samples in the amount of N are conducted with column analysis and row analysis, and sample row vector and sample column vector of the binarized sample are defined, and each binarized sample is numbered with n, template samples in the amount of N are obtained, the sample row vector of each template sample is defined as Pₕ(n), the sample column vector of each template sample is defined as Pᵥ(n), here, the process of building the template sample is finished.

When the image is needed to be matching analyzed, the image is binarized first, and then a matching area in the image as shown in FIG. 8 is selected by the search frame, the size of the matching area (the size of the black background in FIG. 8) is greater than the size of the template sample (the size of the border in FIG. 8); and then average gray-scale value pᵥ(j) in row of the gray-scale values of the pixels in each row of the matching area is calculated according to

$${p}_{v} ( j ) = \frac{1}{{K}_{w}} {\sum }_{i = 0}^{i = {L}_{w} - 1} Q ( i , j ) ,$$

any average gray-scale values in row in the amount of K_{w} are selected from left side to the right side to define search column vectors in the amount of L_{w}−K_{w}+1, for example, the first search column vector from the left is numbered with pᵥ^{0,K}^{_{w}}⁻¹, and then similarities among search column vectors in the amount of L_{w}−K_{w}+1 in the matching area and column vector of the template samples in the amount of N are respectively calculated, and then the maximum similarity corresponding to each template sample is selected according to the calculated similarities in the amount of N*(L_{w}−K_{w}+1), and then the top five maximum similarities are selected from the maximum similarities in the amount of N, the template samples corresponding to these five maximum similarities are taken as middle template samples, five respective row areas are determined according to search column vectors of the matching area corresponding to these five maximum similarities, here, the process of row matching the matching area is finished.

Then, these five middle template samples are column matched to the respective row areas in the matching area. FIG. 9 shows the target row area in the matching area corresponding to single middle template sample, in regards to the target row area, it is similar to the aforementioned row matching process, any average gray-scale values in column in the amount of Kₕ are selected from top side to the bottom side to define search row vectors in the amount of Lₕ−Kₕ+1, and then similarities among column vector of each middle template sample and search column vectors in the amount of Lₕ−Kₕ+1 defined in the respective row area are calculated to obtain five maximum similarities of the middle template samples, the maximum one is selected from these five maximum similarities, and then the middle template sample corresponding to the maximum one is determined as matching template sample, and an area in the matching area where the search column vector and the search row vector correspond to the maximum one is determined as the target area.

One embodiment of the present disclosure provides a non-volatile computer storage medium capable of storing computer-executable instruction. The said computer-executable instruction is used for performing any one of the methods for image matching as discussed in above.

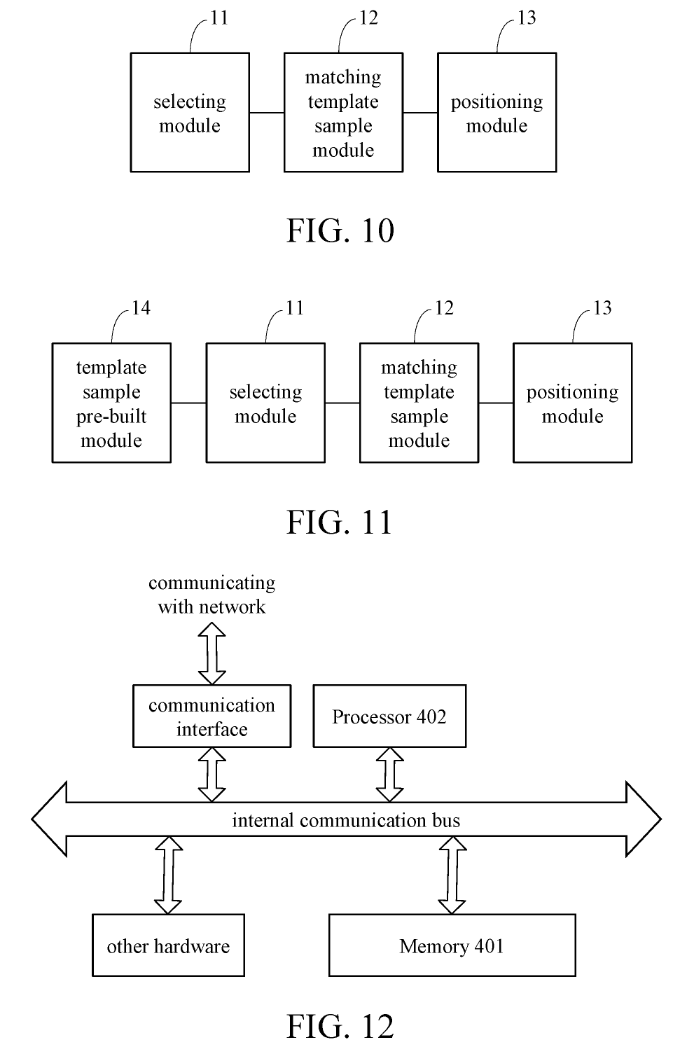

Please refer to FIG. 10, the present disclosure provides an electronic apparatus for matching image, the electronic apparatus includes:

a selecting module 11 used to determine an matching area according to where a search frame is located in an image, wherein a size of the matching area is greater than a size of a template sample;

a matching template sample module 12 used to calculate average gray-scale value of pixels in each column/row in the matching area, calculate average gray-scale value of pixels in the matching area in any consecutive columns/rows corresponding to the quantity of the columns/rows of the pixels in any one of the pre-built template samples, calculate similarity among the average gray-scale value of the pixels in the matching area and average gray-scale value of the pixels in columns/rows of the template sample, and take the template sample corresponding to the maximum similarity as an image matching template sample;

a positioning module 13 used to take an area where the pixels in the columns/rows of the matching area corresponding to the maximum similarity as a target area.

Wherein, the selecting module 11 is able to determine the matching area on the image by the search frame, the determined matching area is be taken as an area used to be compared with the template sample in the following processes. The size of the matching area is greater than the size of the template sample, so the problem in matching imprecisely caused by the location of the pattern in the image can be prevented. The final template sample can match a part of the matching area, for example, as shown in FIG. 8, the range of the black background corresponds to the size of the matching area, and the range of the border of the black background represents the size of the template sample.

In the matching template sample module 12, the average gray-scale value in column/row in the matching area is calculated first, and then the average gray-scale value in each column in the matching area is compared with average gray-scale value in each column in the several template samples, or the average gray-scale value in each row in the matching area is compared with average gray-scale value in each row in the several template samples. The size of the matching area is greater than the size of the template sample, so the quantity of the average gray-scale value in column/row of the matching area is greater than the quantity of the average gray-scale value in column/row of the template sample. During the comparison, in each template sample, average gray-scale value of pixels in the matching area in any consecutive columns/rows corresponding to the quantity of the columns/rows in the template sample are calculated, the similarity between the average gray-scale value of the pixels in the matching area and average gray-scale value of the pixels in columns/rows of the template sample is calculated, the matching template sample corresponding to the maximum similarity and a target area in the matching area can be determined by matching and comparing, e.g. in FIG. 8, the range of the border is the target area, and the size of the determined target area is the same as the size of the template sample.

The gray-scale values of the pixels are different in different images, features of pixels in each column/row of the matching area can be determined according to average gray-scale value in column/row of the matching area. Specifically, the average gray-scale value in column/row is calculated after the image is converted into a binarized image, and during the calculation of the average gray-scale value in column/row, the gray-scale values of the pixels in the area of the matching area larger than (outside) the template sample is defined as 0, thus, during the calculation of the average gray-scale value in column/row, the quantity of the pixels in each column/row is defined as the same as the quantity of the pixels in each column/row of the template sample. If the average gray-scale value in each column/row in the template sample matches the quantity in the matching area, and the average gray-scale value in adjacent columns/rows are matched to each other, it proofs that the pattern of the template sample is the same as or highly similar to the pattern of the target area in the matching area. By doing so, the template sample adapted to industrial processing or other applications can be determined, and the target area can be determined from the image. For example, the method can be used to analyze defect or printing quality in the target area.

The matching template sample module 12 is able to calculate the average gray-scale value of pixels of the matching area in any consecutive columns/rows corresponding to the quantity of the columns/rows of the template sample, and calculate the similarity between the average gray-scale value of the pixels in the matching area and the average gray-scale value in column/row of the template sample can be implemented by various ways, there are several embodiments for exemplary explaining the calculations.

In one embodiment, the matching template sample module 12 is used to:

calculate average gray-scale value in row according to gray-scale values of the pixels in each row of the matching area, define search column vectors in the amount of L_{w}−K_{w}+1 according to average gray-scale values in any consecutive rows which are in the amount of K_{w}, wherein K_{w} represents the quantity of the rows in the template sample, L_{w} represents the quantity of the rows in the matching area, and L_{w}>K_{w};

calculate similarity between each search column vector of the matching area and sample column vectors of the several template samples to determine a pair of the search column vector and the sample column vector which correspond to the maximum similarity; and

take the template sample corresponding to the determined sample column vector as a matching template sample.

In this embodiment, the matching template sample module 12 is able to calculate the average gray-scale value of the pixels in each row of the matching area according to

$${p}_{v} ( j ) - \frac{1}{{K}_{w}} {\sum }_{i = 0}^{i = {L}_{w} - 1} Q ( i , j ) ,$$

wherein, Q(i,j) represents gray-scale value of pixel in the matching area, i represents column coordinate of pixel, j represents row coordinate of pixel, K_{w} represents the quantity of the rows of the template sample. By calculation, the average gray-scale values in row in the amount of L_{w} of the matching area are obtained, and any adjacent average gray-scale values in row in the amount of K_{w} is defined as a search column vector. For example, the 0^{th}˜K_{w}−1^{th} average gray-scale values in row is defined as a search column vector, or the 1^{st}˜K_{w}^{th}, the 2^{nd}˜K_{w}+1^{th}, the 3^{rd}˜K_{w}+2^{nd} average gray-scale values in row can be defined as a search column vector. By doing so, it is noted that the quantity of the search column vectors is L_{w}−K_{w}+1. The length of the search column vector is the same as the length of the sample column vector in the template sample. For the search column vectors in the amount of L_{w}−K_{w}+1 defined by the step S201, in the step S202, each search column vector is compared with the sample column vectors of the several template samples which are built in advance, and the similarity between the search column vector and the sample column vector is calculated. If the quantity of the template samples is N, then the quantity of the calculated similarities will be N*(L_{w}−K_{w}+1), and then the maximum similarity is selected from these calculated similarities, and the template sample having the column vector corresponding to the maximum similarity is taken as a matching template sample. The positioning module 13 is able to take an area where the pixels in the matching area having the search column vector corresponding to the maximum similarity as a target area.

In another embodiment, the matching template sample module 12 is used to:

calculate average gray-scale value in column according to gray-scale values of the pixels in each column of the matching area, define search row vectors in the amount of Lₕ−Kₕ+1 according to average gray-scale values in any consecutive columns which are in the amount of Kₕ, wherein Lₕ represents the quantity of the columns in the matching area, Kₕ represents the quantity of the columns in the template sample, and Lₕ>Kₕ;

calculate similarity between each search row vector of the matching area and sample row vectors of the several template samples to determine a pair of the search row vector and sample row vector which correspond to the maximum similarity; and

take the template sample having the determined sample row vector as a matching template sample.

In this embodiment, the matching template sample module 12 is able to calculate the average gray-scale value of the pixels in each column of the matching area according to

$${p}_{h} ( i ) - \frac{1}{{K}_{h}} {\sum }_{j = 0}^{j = {L}_{h} - 1} Q ( i , j ) ,$$

wherein, Q(i,j) represents gray-scale value of each pixel in the matching area, i represents column coordinate of pixel, j represents row coordinate of pixel, Kₕ represents the quantity of the columns of the template sample. By the calculation, the average gray-scale values in column in the amount of Lₕ of the matching area are obtained, and any adjacent average gray-scale values in column in the amount of Kₕ is defined as a search row vector. For example, the 0^{th}˜Kₕ−1^{th} average gray-scale values in column is defined as a search row vector, or the 1^{st}˜Kₕ^{th}, the 2^{nd}˜Kₕ+1^{th}, or the 3^{rd}˜Kₕ+2^{nd} average gray-scale values in column can be defined as a search row vector. By doing so, it is noted that the quantity of the search row vectors is Lₕ−Kₕ+1. The length of the search row vector is the same as the length of the sample row vector of the template sample. For the search row vector in the amount of Lₕ−Kₕ+1 defined by the step S211, in the step S212, each search row vector is compared with the sample row vector of the several template samples, and the similarity between the search row vector and the sample row vector is calculated. If the quantity of the template samples is N, then the quantity of the calculated similarities will be N*(Lₕ−Kₕ+1), and then the maximum similarity is selected from these calculated similarities, and the template sample having the sample row vector corresponding to the maximum similarity is taken as a matching template sample. The positioning module 13 is able to take an area where the pixels in the matching area having the search row vector corresponding to the maximum similarity as a target area.

In another embodiment, the matching template sample module 12 is used to:

calculate average gray-scale value in row according to gray-scale values of the pixels in each row of the matching area, define search column vectors in the amount of L_{w}−K_{w}+1 according to average gray-scale values in any consecutive rows which are in the amount of K_{w}, wherein L_{w} represents the quantity of the rows in the matching area, K_{w} represents the quantity of the rows in the template sample, and L_{w}>K_{w};

calculate similarity between each search column vector of the matching area and column vectors of the several template samples to determine several pairs of the search column vectors and the column vectors that their similarities are greater than a predetermined threshold value;

take the template samples having the determined column vectors as middle template samples;

calculate average gray-scale value in column according to gray-scale values of the pixels in each column of the matching area, define search row vectors in the amount of Lₕ−Kₕ+1 according to average gray-scale values in any consecutive columns which are in the amount of Kₕ, wherein Lₕ represents the quantity of the columns in the matching area, Kₕ represents the quantity of the rows in the template sample, and Lₕ>Kₕ;

calculate similarity between each row vector in the matching area and sample row vectors of the middle template samples to determine a pair of the search row vector and the sample row vector which correspond to the maximum similarity; and

take the middle template sample having the determined sample row vector as a matching template sample.

In this embodiment, the matching template sample module 12 is able to calculate the average gray-scale value of the pixels in each row of the matching area according to

$${p}_{v} ( j ) = \frac{1}{{K}_{w}} {\sum }_{i = 0}^{i = {L}_{w} - 1} Q ( i , j ) ,$$

wherein, Q(i,j) represents gray-scale value of pixel in the matching area, i represents column coordinate of pixel, j represents row coordinate of pixel, K_{w} represents the quantity of the rows of the template sample. By calculation, the average gray-scale values in row in the amount of L_{w} of the matching area are obtained, and any adjacent average gray-scale values in row in the amount of K_{w} is defined as a search column vector, the quantity of the search column vectors is defined as L_{w}−K_{w}+1. The length of the search column vector is the same as the length of the sample column vector in the template sample. For the search column vectors in the amount of L_{w}−K_{w}+1 defined by the step S221, the matching template sample module 12 takes each search column vector to compare with the pre-built column vectors of the several template samples, and calculates similarity between the search column vector and the column vector. If the quantity of the template samples is N, then the quantity of the calculated similarities will be N*(L_{w}−K_{w}+1), and then the similarities greater than the predetermined threshold value are selected from the similarities in the amount of N*(L_{w}−K_{w}+1), or a predetermined amount of the relatively strong similarities arranged in the top of a list of all the calculated similarities are selected, the template sample corresponding to the selected similarity by the matching template sample module 12 is determined as a middle template sample, the amount of the middle template samples determined by the matching template sample module 12 is very less than the total amount of the template samples. After the matching process of the matching area and the middle temple sample determined in the matching template sample module 12, the maximum similarity is selected from the similarities among each search row vector of the matching area and the sample row vector of the middle template samples, and the middle template sample corresponding to the maximum similarity is taken as a matching template sample.

In this embodiment, the matching area and all the template sample are conducted with row matching process to choose several template samples having highly matched rows to be taken as middle template samples, and then the matching area and the middle template samples are conducted with column matching process to choose the middle template sample having the highest column matching to be taken as a matching template sample. By two matching processes, the relationship among the matching area and the template samples can be confirmed more precise, so it is favorable for determining the target area in the matching area and analyzing the target area.

In addition, this embodiment provides an exemplary explanation that the matching template sample module 12 performs the process of row matching the matching area and all template samples ahead of the process of column matching the matching area and the middle template sample, similarly, it is acceptable to let the matching template sample module 12 to perform the process of column matching the matching area and all the template samples, and then perform the process of row matching the matching area and the middle template sample, the result of image matching is precise as well.

In another embodiment, the matching template sample module 12 is used to:

calculate average gray-scale value in row according to gray-scale values of the pixels in each row of the matching area, define search column vectors in the amount of L_{w}−K_{w}+1 according to average gray-scale values in any consecutive rows which are in the amount of K_{w}, wherein L_{w} represents the quantity of the rows in the matching area, K_{w} represents the quantity of the rows in the template sample, and L_{w}>K_{w};

compare search column vector of the image and the sample column vectors of the several template samples to determine search column vector from the column vector in each template sample corresponding to the maximum similarity;

calculate similarity between the search column vector of the image and the sample column vectors of the several template samples to determine the maximum similarity of each template sample;

determine row area in the matching area according to the search column vector corresponding to the middle template sample, calculate average gray-scale value of the pixels in each column in the row area in the matching area, define search row vectors in the amount of Lₕ−Kₕ+1 according to average gray-scale values in any consecutive columns which are in the amount of Kₕ, wherein Lₕ represents the quantity of the columns in the matching area, Kₕ represents the quantity of the columns in the template sample, and Lₕ>Kₕ;

calculate similarity between the sample row vector of the middle template sample and the search row vector in the row area in the matching area to determine the maximum similarity corresponding to each middle template sample; and

determine the maximum among the maximum similarities in the middle template samples, and take the middle template sample having the maximum value as a matching template sample.

The matching template sample module 12 is able to calculate the average gray-scale value of the pixels in each row of the matching area according to

$${p}_{v} ( j ) = \frac{1}{{K}_{h}} {\sum }_{i = 0}^{i = {L}_{h} - 1} Q ( i , j ) ,$$

wherein Q(i,j) represents gray-scale value of pixel in the matching area, i represents column coordinate of pixel, j represents row coordinate of pixel, K_{w} represents the quantity of the rows of the template sample. Here, by comparing the matching area with the template sample, the gray-scale values of the extra pixels in each row are 0, according to the aforementioned formula, the quantity of the usable pixels in row of the matching area is taken as a calculation standard of the average gray-scale value in row, and the quantity of the usable pixels in row is the same as the quantity of the pixels in row of the template sample. Therefore, the similarity between the average gray-scale value in row and the average gray-scale value in row of the template sample can be precise. By calculation, average gray-scale values in row in the amount of L_{w} of the matching area are obtained, any adjacent average gray-scale values in row in the amount of K_{w} are defined as a search column vector, and the quantity of the search column vectors is defined as L_{w}−K_{w}+1. For each template sample, its sample column vectors are conducted similarity calculation with the search column vectors in the amount of L_{w}−K_{w}+1 in the matching area, each template sample will obtain similarities in the amount of L_{w}−K_{w}+1, and a maximum similarity is selected from these similarities. If the quantity of the template samples is N, then the matching template sample module 12 is able to determine maximum similarities in the amount of N. By the step S233, a certain amount of maximum similarities or the maximum similarities greater than the predetermined threshold value are selected from these maximum similarities. These maximum similarities can be arranged in order, and a predetermined amount of the maximum similarities arranged in the top of a list of all the calculated maximum similarities are selected. The template sample having the selected maximum similarity is taken as a middle template sample.

For each middle template sample, a row area in the matching area corresponding to the middle template sample shown in FIG. 9 can be obtain according to the relationship between the column vector and the search column vector of the matching area, the matching template sample module 12 is able to perform oppositely matching from the angle of the middle template sample, when determining the row area of the matching area, average gray-scale value of the pixels in each column in the row area is calculated according to

$${p}_{h} ( i ) = \frac{1}{{K}_{w}} {\sum }_{j = 0}^{j < {K}_{w}} I ( i , j )$$

to obtain average gray-scale values in column in the amount of Lₕ. According to the obtained average gray-scale values in column in the amount of Lₕ, the quantity of the search row vectors in the length of Kₕ is Lₕ−Kₕ+1, and the length of the search row vector is the same as the length of the sample row vector of the middle template sample. Then, by the matching template sample module 12, the similarity between the column vector of the middle template sample and the search row area of the matching area is calculated for determining the maximum similarity corresponding to each middle template sample, By the matching template sample module 12, the maximum among these maximum similarities is determined, the middle template sample corresponding to the maximum one is taken as the matching template sample, and an area in the matching area where the search column vector and the search row vector correspond to the maximum one is taken as the target area.

In this embodiment, the matching area and all the template samples are conducted with row matching process, maximum similarity among each template sample and the matching area is obtained, several preferable middle template samples are selected according to the maximum similarity of each template sample, and then the best matching row area in the matching area corresponding to these middle template samples is determined; and then the determined row area of the matching area and the middle template sample are conducted with matching process, this matching process is merely used to calculate the average gray-scale value in column in the determined row area. By the matching template sample module 12, search row vector of the matching area is defined according to the average gray-scale value in each column in the calculated row area, and similarity between the calculated search row vector and the sample row vector of the middle template sample is calculated. If the quantity of the template samples is n, and then there are similarities in the amount of n*(Lₕ−Kₕ+1), and the maximum one is selected from these similarities, and the middle template sample corresponding to the maximum one is taken as a matching template sample. Wherein, by the matching template sample module 12, the maximum among the similarities in the amount of n*(Lₕ−Kₕ+1) is selected, the maximum similarity corresponding to each middle template sample can be calculated first, and then the maximum among these maximum similarities in the amount of n is selected, or the maximum among these similarities in the amount of n*(Lₕ−Kₕ+1) is selected, and the other ways of selecting are adaptable, the present disclosure it not limited thereto.

In addition, this embodiment provides an exemplary explanation that the process of row matching the matching area and all the template samples by the matching template sample module 12 is ahead of the process of column matching the matching area and the middle template samples, similarly, it is acceptable that the matching template sample module 12 can perform column matching the matching area and all the template sample first, and then perform row matching the matching area and the middle template sample, the result of image matching is precise obtained as well. These two methods both fall within the scope of the present disclosure. By this embodiment, several most matching column/row areas of the matching area and the template sample can be confirmed, and then the matched column/row areas are conducted with row/column matching to ensure that the target area is more precise. The result of matching is precise in the position of the pixel in the image, thus, it can provide more precise result than the traditional methods do.

In the embodiments in above, there are many usable ways; here is a similar exemplary explanation of angle among vectors.

the matching template sample module 12 is used to:

calculate the similarity between the search column/row vector of the matching area and sample column/row vector of the template sample according to

$${d}_{n , m =} \frac{{p}^{m , m + {K}_{w} - 1} \cdot P ( n )}{\vert {p}^{m , m + {K}_{w} - 1} \vert \vert P ( n ) \vert} ,$$

wherein, m represents that the search column/row vector is started from row/column average gray-scale value in the m^{th} row/column in the matching area, P (n) represents sample column/row vector in the n^{th} the template sample, p^{m,m+K}^{_{w}}⁻¹ represents search column/row vector of the matching area.

For example, the angle between the search column vector defined by the 0˜K_{w}−1^{th} row average value and the column vector of the template sample is calculated according to

$${θ}_{n , 0} = {cos}^{- 1} [ \frac{{p}_{v}^{0 , {K}_{w} - 1} \cdot {P}_{v} ( n )}{\vert {p}_{v}^{0 , {K}_{w} - 1} \vert \vert {P}_{v} ( n ) \vert} ] ,$$

and wherein the form of

$$\frac{{p}_{v}^{0 , {K}_{w} - 1} \cdot {P}_{v} ( n )}{\vert {p}_{v}^{0 , {K}_{w} - 1} \vert \vert {P}_{v} ( n ) \vert}$$

is taken as the similarity d_{n, 0} between the two vectors, when the similarity is greater, the angle between the two vectors is smaller. Similarly, the similarity between the search row vector of the matching area and the template sample is calculated according to

$${d}_{n , m =} \frac{{p}^{m , m + {K}_{w} - 1} \cdot P ( n )}{\vert {p}^{m , m + {K}_{w} - 1} \vert \vert P ( n ) \vert} .$$

In the embodiments in above, they can get different amount of similarities according to different calculation parameters, comparative targets, they finally all can find a pair of sample column/row vector and search column/row vector which have smallest difference and highest matching level, and thereby precisely determining the target area matching the template sample and the matching area.

Please refer to FIG. 11; the following is another embodiment for explaining the process of pre-building the template sample in detail. The pre-building of the template sample provides the basic for calculating the similarity in the above embodiments.

In this embodiment, the electronic apparatus for image matching includes:

The template sample pre-built module 14, which is used to:

collect image from standard sample image according to image collecting frame, obtain several collected image samples, binarize the collected image sample to obtain binarized sample, wherein, the size of the image collecting frame is K_{w}*Kₕ;

calculate an average gray-scale value of the pixels in each column and an average gray-scale value of the pixels in each row in the binarized sample, define all the average values in columns in the binarized sample as sample row vector having a length which is K_{w}, define all the average values in rows in the binarized sample as sample column vector having a length which is Kₕ; and

number each binarized sample, and take the several binarized samples which are numbered and have defined sample row vector and sample column vector as template samples.

In the template sample pre-built module 14, the period of collecting image can be set according to actual condition, the image collecting can be conducted in each 3˜5 degrees to prevent the image collecting from costing too much time, and ensure the collected image sample meets requirement. The sample image should be standard sample in order to prevent from generating imprecise template sample while collecting image on non-standard sample. In addition, the image collecting frame should face the standard sample image while collecting image, and the size of the image collecting frame should not be too big in order to prevent the collected image sample from distorting to generate imprecise template sample while the size of the collected image is too big. In addition, the process of binarizing is used to convert the gray-scale values of value 0 and value 255, there are many ways for converting. For example, if the luminance of the image is stable, the Valve Binarization can be used to collect the image to convert gray-scale value, the other methods, e.g. Top Hat, Black Hat, edge extraction, the present disclosure is not limited thereto.

In the template sample pre-built module 14, in the binarized sample obtained by the binarizing process, average gray-scale value in column and average gray-scale value in row is calculated column by column and row by row, average gray-scale value in column of the binarized sample is calculated according to

$${P}_{h} ( i ) = \frac{1}{{K}_{w}} {\sum }_{j = 0}^{j < {K}_{w}} I ( i , j ) ,$$

average gray-scale value in row of the binarized sample is calculated according to

$${P}_{v} ( j ) = \frac{1}{{K}_{h}} {\sum }_{i = 0}^{i < {K}_{h}} I ( i , j ) ,$$

wherein I(i,j) represents gray-scale value of pixel in the binarized sample, i represents column coordinate of pixel, j represents row coordinate of pixel, K_{w} represents the quantity of the rows of the binarized sample, Kₕ represents the quantity of the columns of the binarized sample. By step S402, the average gray-scale values in row in the amount of K_{w} and the average gray-scale values in column in the amount of Kₕ are obtained, and these average gray-scale values in row in the amount of K_{w} of the binarized sample are defined as sample column vector, these average gray-scale values in column in the amount of Kₕ are defined as sample row vector.

By the template sample pre-built module 14, the sample row vector and the sample column vector are numbered in the binarized sample to generate template samples, and the template samples are numbered as well for conveniently finding the matching template sample while matching image in the later processes.

Preferably, in this embodiment, the template sample pre-built module 14 is used to:

delete useless collected image sample, wherein the useless collected image sample comprises: the collected image having an image collecting angle having a difference less than a predetermined threshold value with respect to an image collecting angle of the pervious collected image sample; or the collected image sample having no image;

Deleting useless collected image sample is used for shortening time of sample analysis, wherein the final amount of the collected image sample ranging between 80 and 180 satisfies the requirement of image collecting.

This embodiment replace the traditional method that the template sample should be the whole image, it generates plural independent template samples for image matching, thus, the process of assembling images are removed, and thereby preventing the problem in matching imprecisely caused by images assembling; Also, in this embodiment, each template sample has numbered sample row vector and sample column vector for achieving high-precise image matching.

By the method and electronic apparatus of image matching provided by the embodiments of the present disclosure, various kinds of images in the image can be matched precisely, even the image with complicated patterns, the process of assembling images are removed by several independent template samples, so the result of image matching is precise, and the speed of image matching is fast.

FIG. 12 is a schematic view of an electronic apparatus connected to hardware for matching image according to one embodiment of the present disclosure, the electronic apparatus includes:

a memory 401 and one or more processors 402. FIG. 12 is an example showing that the electronic apparatus having one processor 402.

The processor 402, the memory 401 can be connected to each other via a bus or other members for electrical connection. In FIG. 12, they are connected to each other via the bus in this embodiment.

The memory 401 is one kind of non-volatile computer-readable storage mediums applicable to store non-volatile software programs, non-volatile computer-executable programs and modules; for example, the program instructions and the function modules, e.g. program instruction/module corresponding to the method in the embodiments of the present disclosure. The processor 402 executes function applications and data processing of the server by running the non-volatile software programs, non-volatile computer-executable programs and modules stored in the memory 401, and thereby the methods in the aforementioned embodiments are achievable.

The memory 401 can include a program storage area and a data storage area, wherein the program storage area can store an operating system and at least one application program required for a function; the data storage area can store the data created according to the usage of the device for intelligent recommendation. Furthermore, the memory 401 can include a high speed random-access memory, and further include a non-volatile memory such as at least one disk storage member, at least one flash memory member and other non-volatile solid state storage member. In some embodiments, the memory 401 can have a remote connection with the processor 402, and such memory can be connected to the device of the present disclosure by a network. The aforementioned network includes, but not limited to, internet, intranet, local area network, mobile communication network and combination thereof.

The one or more modules are stored in the memory 401. When the one or more modules are executed by one or more processor 401, the methods of matching image disclosed in any one of the embodiments are performed.

The aforementioned product can perform the method of the present disclosure, and has function module for performing it. The details not thoroughly illustrated in this embodiment can be referenced via the methods in the present disclosure.

Please refer to FIG. 12, one embodiment of the present disclosure provides an apparatus for image matching, the apparatus includes: a memory 401 and a processor 402, wherein,

the memory 401 is configured to store one or more computer-executable instructions for the processor, wherein the computer-executable instruction is used for the processor 402 to perform;

the processor 402 is used to determine an matching area in an image according to where the search frame is located in the image, wherein, a size of the matching area is greater than a size of the template sample;

used to calculate average gray-scale value of pixels in each column/row in the matching area, calculate average gray-scale value of pixels in the matching area in any consecutive columns/rows corresponding to the quantity of the columns/rows of the pixels in any one of the pre-built template samples, calculate similarity between the average gray-scale value of the pixels in the matching area and average gray-scale value in column/row of the template sample, and take the template sample corresponding to the maximum similarity as an image matching template sample;

used to take area where the pixels in the columns/rows of the matching area corresponding to the maximum similarity as a target area.

The processor 402 is further used to: calculate average gray-scale value of the pixels in row of the matching area according to gray-scale values of the pixels in each row of the matching area, defining search column vectors in the amount of L_{w}−K_{w}+1 according to average gray-scale values in any consecutive rows which are in the amount of K_{w}, wherein K_{w} represents the quantity of the rows in the template sample, L_{w} represents the quantity of the rows in the matching area, and L_{w}>K_{w};

calculate similarity between each search column vector of the matching area and sample column vectors of the several template samples to determine a pair of the search column vector and the sample column vector which correspond to the maximum similarity; and

take the template sample which corresponds to the determined sample column vector as a matching template sample.

The processor 402 is further used to: calculate average gray-scale value in column according to gray-scale values of the pixels in each column of the matching area, define search row vectors in the amount of Lₕ−Kₕ+1 according to average gray-scale values in any consecutive columns which are in the amount of Kₕ, wherein Lₕ represents the quantity of the columns in the matching area, Kₕ represents the quantity of the columns in the template sample, and Lₕ>Kₕ;

calculate similarity between each search row vector of the matching area and sample row vectors of the several template samples to determine a pair of the search row vector and sample row vector which correspond to the maximum similarity; and

take the template sample having the determined sample row vector as a matching template sample.

The processor 402 is further used to: calculate average gray-scale value in row according to gray-scale value of the pixels in each row of the matching area, wherein L_{w} represents the quantity of the rows in the matching area, K_{w} represents the quantity of the rows in the template sample, L_{w}>K_{w}, and L_{w}−K_{w}+1 represents the number of search column vectors;

calculate similarity between the search column vector of the matching area and the sample column vector of the several template samples to determine several pairs of the search column vectors and the sample column vectors which have similarities grater than a predetermined threshold value;

take the template sample corresponding to the determined sample column vectors as a middle template sample;

calculate average gray-scale value in column according to gray-scale values of the pixels in each column of the matching area, define search row vectors in the amount of Lₕ−Kₕ+1 according to average gray-scale values in any consecutive columns which are in the amount of Kₕ, wherein Lₕ represents the quantity of the columns in the matching area, Kₕ represents the quantity of the columns in the template sample, and Lₕ>Kₕ;

calculate similarity between each search row vector of the matching area and the sample row vector of the several template samples to determine a pair of the search row vector and the sample row vector which correspond to the maximum similarity; and

take the middle template sample corresponding to the determined sample row vector as a matching template sample.

The processor 402 is further used to: calculating average gray-scale value in row according to gray-scale values of the pixels in each row of the matching area, defining search column vectors in the amount of L_{w}−K_{w}+1 according to average gray-scale values in any consecutive rows which are in the amount of K_{w}, wherein K_{w} represents the quantity of the rows in the template sample, L_{w} represents the quantity of the rows in the matching area, and L_{w}>K_{w};

comparing search column vector of the image and the sample column vectors of the several template samples to determine search column vector from the column vector in each template sample having the maximum similarity;

calculating similarity between the search column vector of the image and the sample column vector of the several template samples to determine the maximum similarity corresponding to each template sample;

determining row area in the matching area according to the search column vector corresponding to the middle template sample, calculating average gray-scale value of the pixels in each column in the row area in the matching area, defining search row vectors in the amount of Lₕ−Kₕ+1 according to average gray-scale values in any consecutive columns which are in the amount of Kₕ, wherein Lₕ represents the quantity of the columns in the matching area, Kₕ represents the quantity of the columns in the template sample, and Lₕ>Kₕ;

calculating similarity between the sample row vector of the middle template sample and the search row vector in the row area in the matching area to determine the maximum similarity in each middle template sample; and

determining the maximum among the maximum similarities in the middle template samples, and taking the middle template sample having the maximum value as a matching template sample.

The processor 402 is further used to: collecting image sample from standard sample image according to image collecting frame, binarizing the collected image sample to obtain a binarized sample, wherein the size of the image collecting frame is K_{w}*Kₕ;

calculating an average gray-scale value of the pixels in each column and an average gray-scale value of the pixels in each row in the binarized sample, defining all the average values in columns in the binarized sample as sample row vector having a length which is K_{w}, defining all the average values in rows in the binarized sample as sample column vector having a length which is Kₕ; and

numbering each binarized sample, and taking the several binarized samples which are numbered and have defined sample row vector and sample column vector as template samples.

The processor 402 is used to: delete useless collected image sample, wherein the useless collected image sample comprises: the collected image having an image collecting angle having a difference less than a predetermined threshold value with respect to an image collecting angle of the pervious collected image sample; or the collected image sample having no image.

The processor 402 is used to:

calculate similarity between search column/row vector in the matching area and sample column/row vector in the template sample according to

$${d}_{n , m =} \frac{{p}^{m , m + {K}_{w} - 1} \cdot P ( n )}{\vert {p}^{m , m + {K}_{w} - 1} \vert \vert P ( n ) \vert} ,$$

wherein, m represents that the search column/row vector is started from row/column average gray-scale value in the m^{th} row/column in the matching area, P (n) represents sample column/row vector in the n^{th} template sample, p^{m,m+K}^{_{w}}⁻¹ represents search column/row vector of the matching area.

The electronic apparatus in the embodiments of the present application is presence in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

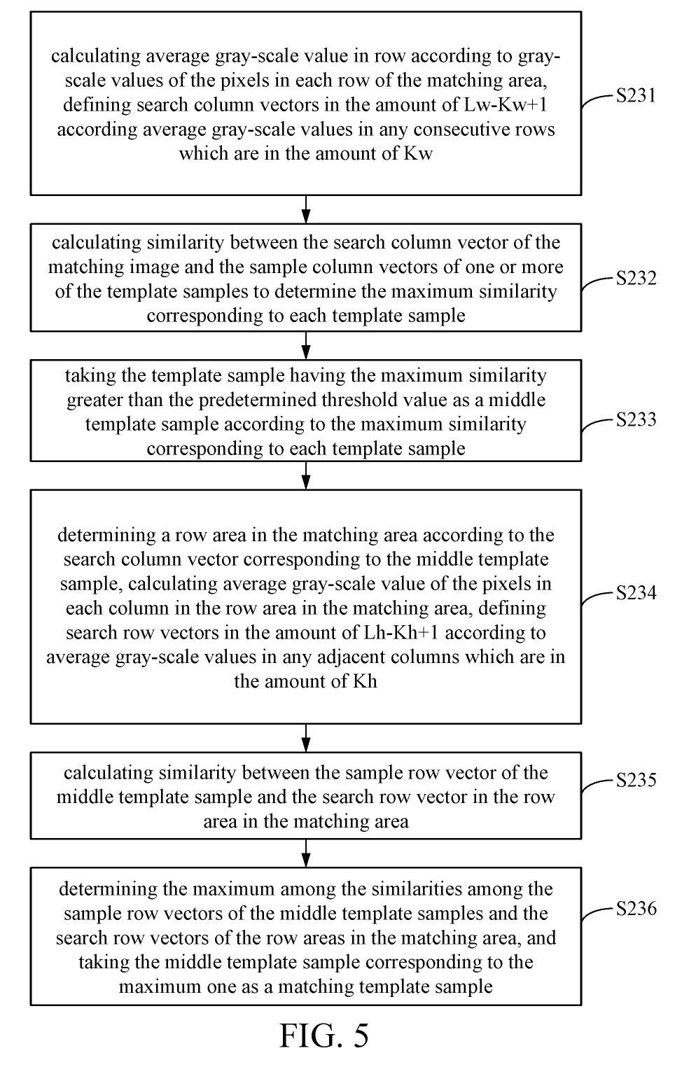

In this embodiment, the technique, the features of each function module and the relationships correspond to the technique and the features of the embodiments in FIGS. 1 to 12, the complete content are in the embodiments in FIGS. 1 to 12.

The aforementioned embodiments are exemplary, the description of separated units can be physically connected, and the unit capable of displaying image can not be a physical unit, that is, it can be located on a place or distributed to plural internet units. It is selectively to select a part or all of the modules for achieving the purpose of the present disclosure. The people skilled in the art can understand and perform the present disclosure without putting inventive effort.

By the aforementioned embodiments, the people skilled in the art can thoroughly understand that the embodiments can be implemented by software and hardware platform. Accordingly, the technique, features or the part having contribution can be embodied through software product, the software product can be stored in computer readable medium, such as ROM/RAM, hard disk, optical disc, including one or more instructions so that a computing apparatus (e.g. personal computer, server, or internet apparatus can execute each embodiment or some methods discussed the embodiments.

It is further noted that: the embodiments in above are only used to explain the features of the present application, but not used to limit the present application; although the present application is explained by the embodiments, the people skilled in the art would know that the features in the aforementioned embodiments can be modified, or a part of the features can be replaced, and the features relating to these modification or replacement are still in the scope and spirit of the present application.

What is claimed is:

1. A method of matching image adapted to a terminal, comprising:
S101: determining a matching area in an image according to a search frame, wherein a size of the matching area is greater than a size of a template sample;
S102: calculating average gray-scale value of pixels in each column/row in the matching area, calculating average gray-scale value of pixels in the matching area in any consecutive columns/rows corresponding to the quantity of the columns/rows in any one of the pre-built template sample, calculating similarity among the average gray-scale value of the pixels in the matching area and average gray-scale value of pixels in columns/rows of the template sample, and taking the template sample corresponding to the maximum similarity as a matching template sample; and
S103: taking an area where the pixels in the columns/rows of the matching area corresponding to the maximum similarity as a target area.

2. The method according to claim 1, wherein the step of S102 comprises:
calculating average gray-scale value in row according to gray-scale values of the pixels in each row of the matching area, defining search column vectors in the amount of L_{w}−K_{w}+1 according to average gray-scale values in any consecutive rows which are in the amount of K_{w}, wherein K_{w} represents the quantity of the rows in the template sample, L_{w} represents the quantity of the rows in the matching area, and L_{w}>K_{w};
calculating similarity among each search column vector of the matching area and sample column vectors of the several template samples to determine a pair of the search column vector and the sample column vector which correspond to the maximum similarity; and
taking the template sample corresponding to the determined sample column vector as a matching template sample.

3. The method according to claim 1, wherein the step of S102 comprises:
calculating average gray-scale value in column according to gray-scale values of the pixels in each column of the matching area, defining search row vectors in the amount of Lₕ−Kₕ+1 according to average gray-scale values in any adjacent columns which are in the amount of Kₕ, wherein Lₕ represents the quantity of the columns in the matching area, Kₕ represents the quantity of the columns in the template sample, and Lₕ>Kₕ;
calculating similarity among each search row vector of the matching area and sample row vectors of the several template samples to determine a pair of the search row vector and sample row vector which correspond to the maximum similarity; and
taking the template sample having the determined sample row vector as a matching template sample.

4. The method according to claim 1, wherein the step of S102 comprises:
calculating average gray-scale value in row according to gray-scale values of the pixels in each row of the matching area, defining search column vectors in the amount of L_{w}−K_{w}+1 according to average gray-scale values in any adjacent rows which are in the amount of K_{w}, wherein L_{w} represents the quantity of the rows in the matching area, K_{w} represents the quantity of the rows in the template sample, and L_{w}>K_{w};
calculating similarity among each search column vector of the matching area and column vectors of the several template samples to determine several pairs of the search column vectors and the column vectors that their similarities are greater than a predetermined threshold value;
taking the template samples corresponding to the determined column vectors as middle template samples;
calculating average gray-scale value in column according to gray-scale values of the pixels in each column of the matching area, defining search row vectors in the amount of Lₕ−Kₕ+1 according to average gray-scale values in any adjacent columns which are in the amount of Kₕ, wherein Lₕ represents the quantity of the columns in the matching area, Kₕ represents the quantity of the rows in the template sample, and Lₕ>Kₕ;
calculating similarity among each search row vector in the matching area and sample row vectors of the middle template samples to determine a pair of the search row vector and the sample row vector which correspond to the maximum similarity; and
taking the middle template sample corresponding to the determined sample row vector as a matching template sample.

5. The method according to claim 1, wherein the step of S102 comprises:
calculating average gray-scale value in row according to gray-scale values of the pixels in each row of the matching area, defining search column vectors in the amount of L_{w}−K_{w}+1 according to average gray-scale values in any adjacent rows which are in the amount of K_{w}, wherein L_{w} represents the quantity of the rows in the matching area, K_{w} represents the quantity of the rows in the template sample, and L_{w}>K_{w};
calculating similarity among the search column vector of the image and the sample column vectors of the several template samples to determine the maximum similarity of each template sample;
taking the template sample corresponding to the maximum similarity greater than the a predetermined threshold value as a middle template sample according to the maximum similarity of each template sample;
determining a row area in the matching area according to the search column vector corresponding to the middle template sample, calculating average gray-scale value of the pixels in each column in the row area in the matching area, defining search row vectors in the amount of Lₕ−Kₕ+1 according to average gray-scale values in any adjacent columns which are in the amount of Kₕ, wherein Lₕ represents the quantity of the columns in the matching area, Kₕ represents the quantity of the columns in the template sample, and Lₕ>Kₕ;
calculating similarity among the sample row vector of the middle template sample and the search row vectors in the respective row area in the matching area to determine the maximum similarity corresponding to each middle template sample;
determining the maximum among the maximum similarities corresponding to the middle template samples, and taking the middle template sample corresponding to the maximum value as a matching template sample.

6. The method according to claim 1, wherein the process of pre-building the template sample comprises:
collecting image sample from standard sample image according to image collecting frame, binarizing the collected image sample to obtain a binarized sample, wherein the size of the image collecting frame is K_{w}*Kₕ;
calculating an average gray-scale value of the pixels in each column and an average gray-scale value of the pixels in each row in the binarized sample, defining all the average values in columns in the binarized sample as sample row vector having a length which is K_{w}, defining all the average values in rows in the binarized sample as sample column vector having a length which is Kₕ;
numbering each binarized sample, and taking the several binarized samples which are numbered and have defined sample row vector and sample column vector as template samples.

7. The method according to claim 6, wherein a step before the step of binarizing the collected image sample to obtain a binarized sample, comprises:
deleting useless collected image sample, wherein the useless collected image sample comprises: the collected image having an image collecting angle having a difference less than a predetermined threshold value with respect to an image collecting angle of the pervious collected image sample; or the collected image sample having no image.

8. The method according to one of claim 1, wherein the step of calculating the similarity comprises:
calculating similarity between search column/row vector in the matching area and sample column/row vector in the template sample according to
$${d}_{n , m =} \frac{{p}^{m , m + {K}_{w} - 1} \cdot P ( n )}{\vert {p}^{m , m + {K}_{w} - 1} \vert \vert P ( n ) \vert} ,$$
wherein, m represents that the search column/row vector is started from row/column average gray-scale value in the m^{th} row/column in the matching area, P (n) represents sample column/row vector in the n^{th} template sample, p^{m,m+K}^{_{w}}⁻¹ represents search column/row vector of the matching area.

9. A non-volatile computer storage medium capable of storing computer-executable instruction, the computer-executable instruction comprising:
S101: determining a matching area in an image according to a search frame, wherein a size of the matching area is greater than a size of a template sample;
S102: calculating average gray-scale value of pixels in each column/row in the matching area, calculating average gray-scale value of pixels in the matching area in any consecutive columns/rows corresponding to the quantity of the columns/rows in any one of the pre-built template sample, calculating similarity among the average gray-scale value of the pixels in the matching area and average gray-scale value of pixels in columns/rows of the template sample, and taking the template sample corresponding to the maximum similarity as a matching template sample; and
S103: taking an area where the pixels in the columns/rows of the matching area corresponding to the maximum similarity as a target area.

10. The non-volatile computer storage medium according to claim 9, wherein, the step of S102 comprises:
calculating average gray-scale value in row according to gray-scale values of the pixels in each row of the matching area, defining search column vectors in the amount of L_{w}−K_{w}+1 according to average gray-scale values in any consecutive rows which are in the amount of K_{w}, wherein K_{w} represents the quantity of the rows in the template sample, L_{w} represents the quantity of the rows in the matching area, and L_{w}>K_{w};
calculating similarity among each search column vector of the matching area and sample column vectors of the several template samples to determine a pair of the search column vector and the sample column vector which correspond to the maximum similarity; and
taking the template sample corresponding to the determined sample column vector as a matching template sample.

11. The non-volatile computer storage medium according to claim 9, wherein the step of S102 comprises:
calculating average gray-scale value in column according to gray-scale values of the pixels in each column of the matching area, defining search row vectors in the amount of Lₕ−Kₕ+1 according to average gray-scale values in any adjacent columns which are in the amount of Kₕ, wherein Lₕ represents the quantity of the columns in the matching area, Kₕ represents the quantity of the columns in the template sample, and Lₕ>Kₕ;
calculating similarity among each search row vector of the matching area and sample row vectors of the several template samples to determine a pair of the search row vector and sample row vector which correspond to the maximum similarity; and
taking the template sample having the determined sample row vector as a matching template sample.

12. The non-volatile computer storage medium according to claim 9, wherein the step of S102 comprises:
calculating average gray-scale value in row according to gray-scale values of the pixels in each row of the matching area, defining search column vectors in the amount of L_{w}−K_{w}+1 according to average gray-scale values in any adjacent rows which are in the amount of K_{w}, wherein L_{w} represents the quantity of the rows in the matching area, K_{w} represents the quantity of the rows in the template sample, and L_{w}>K_{w};
calculating similarity among each search column vector of the matching area and column vectors of the several template samples to determine several pairs of the search column vectors and the column vectors that their similarities are greater than a predetermined threshold value;
taking the template samples corresponding to the determined column vectors as middle template samples;
calculating average gray-scale value in column according to gray-scale values of the pixels in each column of the matching area, defining search row vectors in the amount of Lₕ−Kₕ+1 according to average gray-scale values in any adjacent columns which are in the amount of Kₕ, wherein Lₕ represents the quantity of the columns in the matching area, Kₕ represents the quantity of the rows in the template sample, and Lₕ>Kₕ;
calculating similarity among each search row vector in the matching area and sample row vectors of the middle template samples to determine a pair of the search row vector and the sample row vector which correspond to the maximum similarity; and
taking the middle template sample corresponding to the determined sample row vector as a matching template sample.

13. The non-volatile computer storage medium according to claim 9, wherein the step of S102 comprises:
calculating average gray-scale value in row according to gray-scale values of the pixels in each row of the matching area, defining search column vectors in the amount of L_{w}−K_{w}+1 according to average gray-scale values in any adjacent rows which are in the amount of K_{w}, wherein L_{w} represents the quantity of the rows in the matching area, K_{w} represents the quantity of the rows in the template sample, and L_{w}>K_{w};
calculating similarity among the search column vector of the image and the sample column vectors of the several template samples to determine the maximum similarity of each template sample;
taking the template sample corresponding to the maximum similarity greater than the a predetermined threshold value as a middle template sample according to the maximum similarity of each template sample;
determining a row area in the matching area according to the search column vector corresponding to the middle template sample, calculating average gray-scale value of the pixels in each column in the row area in the matching area, defining search row vectors in the amount of Lₕ−Kₕ+1 according to average gray-scale values in any adjacent columns which are in the amount of Kₕ, wherein Lₕ represents the quantity of the columns in the matching area, Kₕ represents the quantity of the columns in the template sample, and Lₕ>Kₕ;
calculating similarity among the sample row vector of the middle template sample and the search row vectors in the respective row area in the matching area to determine the maximum similarity corresponding to each middle template sample;
determining the maximum among the maximum similarities corresponding to the middle template samples, and taking the middle template sample corresponding to the maximum value as a matching template sample.

14. The non-volatile computer storage medium according to claim 9, wherein the process of pre-building the template sample comprises:
collecting image sample from standard sample image according to image collecting frame, binarizing the collected image sample to obtain a binarized sample, wherein the size of the image collecting frame is K_{w}*Kₕ;
calculating an average gray-scale value of the pixels in each column and an average gray-scale value of the pixels in each row in the binarized sample, defining all the average values in columns in the binarized sample as sample row vector having a length which is K_{w}, defining all the average values in rows in the binarized sample as sample column vector having a length which is Kₕ;
numbering each binarized sample, and taking the several binarized samples which are numbered and have defined sample row vector and sample column vector as template samples.

15. The non-volatile computer storage medium according to claim 13, wherein a step before the step of binarizing the collected image sample to obtain a binarized sample, comprises:
deleting useless collected image sample, wherein the useless collected image sample comprises: the collected image having an image collecting angle having a difference less than a predetermined threshold value with respect to an image collecting angle of the pervious collected image sample; or the collected image sample having no image.

16. The non-volatile computer storage medium according to one of claim 9, wherein the step of calculating the similarity comprises:
calculating similarity between search column/row vector in the matching area and sample column/row vector in the template sample according to
$${d}_{n , m =} \frac{{p}^{m , m + {K}_{w} - 1} \cdot P ( n )}{\vert {p}^{m , m + {K}_{w} - 1} \vert \vert P ( n ) \vert} ,$$
wherein, m represents that the search column/row vector is started from row/column average gray-scale value in the m^{th} row/column in the matching area, P (n) represents sample column/row vector in the n^{th} template sample, p^{m,m+K}^{_{w}}⁻¹ represents search column/row vector of the matching area.

17. An electronic apparatus, characterized in, comprising:
at least one processor; and
a memory communicatively connected to the at least one processor; wherein
the memory stores computer-executable instruction which is executable by the at least one processor, when the computer-executable instruction is executed by the at least processor, the at least one processor is able to:
S101: determine a matching area in an image according to a search frame in the image, wherein a size of the matching area is greater than a size of a template sample;
S102: calculate average gray-scale value of pixels in each column/row in the matching area, calculating average gray-scale value of pixels in the matching area in any consecutive columns/rows corresponding to the quantity of the columns/rows in any one of the pre-built template sample, calculating similarity among the average gray-scale value of the pixels in the matching area and average gray-scale value of pixels in columns/rows of the template sample, and taking the template sample corresponding to the maximum similarity as a matching template sample; and
S103: take an area where the pixels in the columns/rows of the matching area corresponding to the maximum similarity as a target area.

18. The electronic apparatus according to claim 17, wherein the step of S102 comprises:
calculating average gray-scale value in row according to gray-scale values of the pixels in each row of the matching area, defining search column vectors in the amount of L_{w}−K_{w}+1 according to average gray-scale values in any consecutive rows which are in the amount of K_{w}, wherein K_{w} represents the quantity of the rows in the template sample, L_{w} represents the quantity of the rows in the matching area, and L_{w}>K_{w};
calculating similarity among each search column vector of the matching area and sample column vectors of the several template samples to determine a pair of the search column vector and the sample column vector which correspond to the maximum similarity; and
taking the template sample corresponding to the determined sample column vector as a matching template sample.

19. The electronic apparatus according to claim 17, wherein the step of S102 comprises:
calculating average gray-scale value in column according to gray-scale values of the pixels in each column of the matching area, defining search row vectors in the amount of Lₕ−Kₕ+1 according to average gray-scale values in any adjacent columns which are in the amount of Kₕ, wherein Lₕ represents the quantity of the columns in the matching area, Kₕ represents the quantity of the columns in the template sample, and Lₕ>Kₕ;
calculating similarity among each search row vector of the matching area and sample row vectors of the several template samples to determine a pair of the search row vector and sample row vector which correspond to the maximum similarity; and
taking the template sample having the determined sample row vector as a matching template sample.

20. The electronic apparatus according to claim 17, wherein the step of S102 comprises:
calculating average gray-scale value in row according to gray-scale values of the pixels in each row of the matching area, defining search column vectors in the amount of L_{w}−K_{w}+1 according to average gray-scale values in any adjacent rows which are in the amount of K_{w}, wherein L_{w} represents the quantity of the rows in the matching area, K_{w} represents the quantity of the rows in the template sample, and L_{w}>K_{w};
calculating similarity among each search column vector of the matching area and column vectors of the several template samples to determine several pairs of the search column vectors and the column vectors that their similarities are greater than a predetermined threshold value;
taking the template samples corresponding to the determined column vectors as middle template samples;
calculating average gray-scale value in column according to gray-scale values of the pixels in each column of the matching area, defining search row vectors in the amount of Lₕ−Kₕ+1 according to average gray-scale values in any adjacent columns which are in the amount of Kₕ, wherein Lₕ represents the quantity of the columns in the matching area, Kₕ represents the quantity of the rows in the template sample, and Lₕ>Kₕ;
calculating similarity among each search row vector in the matching area and sample row vectors of the middle template samples to determine a pair of the search row vector and the sample row vector which correspond to the maximum similarity; and
taking the middle template sample corresponding to the determined sample row vector as a matching template sample.
